(19) United States
(12) Patent Application Publication
(10) Pub. No.: US 2006/0235768 A1
(43) Pub. Date: Oct. 19, 2006

(54) System, method, and computer program product for reducing the burden on inventory system by displaying product availability information for a range of parameters related to a product

(75) Inventors: Alvin D. Tatum JR., North Richland Hills, TX (US); Melvyn Turner, Plano, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc.and Travelocity.com LP.

(21) Appl. No.: 11/088,289

(22) Filed: Mar. 24, 2005

(51) Int. Cl. G06Q 99/00

(52) U.S. Cl. 705/28

(57) ABSTRACT

A system, method, and computer program product for providing results concerning product option availability via an interactive display. The invention generates data for display that shows product options in a multi-axis display wherein the axes correspond to at least two criteria related to the product options. The disclosed system also includes a user interface in communication with the interactive display capable of receiving a user input, such as a filter command, for selecting a portion of the product options such that the interactive display may generate a modified graphical image in response to the user input such that the user may be more completely informed of available product options and therefore select an optimal product option from the displayed product options.

### BACKGROUND OF THE INVENTION

1. Field of the Invention

The present invention relates to the field of mechanized inventory systems, such as airline reservations systems or other product and/or service reservation or inventory systems, which are used to determine availability and pricing for products and/or services. More particularly, the embodiments of the present invention are adapted to display various options for available products and/or services in an interactive format.

2. Description of Related Art

Many of today's products and services are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline seat availability, hotel reservations, car rentals, event availability, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, AND AXESS.

Consumer interaction with these systems has evolved in recent years. Initially, these systems were difficult to use and did not always provide the best solution to a consumer's query. For example, in the early stages, a consumer interested in booking airline tickets would input a desired flight itinerary with desired travel dates and times and possible selected class of travel. The CRS system would check availability for the dates and return with a fare price meeting the specific input dates and times requested. Although there were some algorithms in place to aid the consumer in finding the lowest-priced fare, these algorithms were typically geared more toward providing quick results with less computing time and resources than in finding the lowest priced fare. For example, some early product availability and booking algorithms used a method that would heuristically select a subset of itineraries from a larger pool of itineraries, price this subset, and select the lowest-priced fare from the subset for display to the consumer. While these early systems provided timely results and reduced processing load on the CRS, they did not always provide the best solution to the consumer.

In light of this, SABRE, one of the assignees of the present invention, developed an algorithm, (sometimes referred to as extended implicit enumeration algorithm), that could be used to efficiently determine the lowest fare for a particular flight itinerary. The algorithm used a k-shortest path schema that identified the lowest available fare that met a consumer's request and displayed this fare to the consumer. This algorithm is described more fully in U.S. patent application Ser. No. 09/421,895, filed on Oct. 21, 1999, entitled: Method and Apparatus for Searching for a Low Fare for Travel Between Two Locations, and published as a PCT application under publication number WO0129693; the contents of which are incorporated herein.

The extended implicit enumeration algorithm was a major step forward in efficiently determining the lowest fare price for a given itinerary; it does have a few slight drawbacks. Specifically, the algorithm was designed to provide a small number of low priced answers with minimal consideration of diversity. The consumer inputs a request, and the algorithm returns only the lowest fare meeting the request. Unfortunately, such a process may not provide the best solution to a consumer or may miss an opportunity to market different fares to a customer that may maximize profits for the supplier, while also meeting the consumer's goals. Thus the assignee of the present invention developed a system, method, and computer program product to provide a plurality of low fare prices and different flight itinerary options for a given departure and return date combination, thereby allowing a user to view these different options and make a determination as to which fare and flight itinerary meets their goals as described more fully in U.S. Provisional Patent Application Ser. No. 60/573,546, filed on May 21, 2004, entitled, Systems, Methods, And Computer Program Products For Searching And Displaying Low Cost Product Availability Information For A Given Departure-Return Date Combination Or Range Of Departure-Return Date Combinations; the contents of which are also incorporated herein.

While conventional searching systems for products may provide a user with a multitude of different options in the form of a results listing, the options displayed by such systems are conventionally presented in a manner that may be difficult for the user to fully understand without the need to examine each line of a listing of the options in order to be fully informed of the options returned by the system as well as the impact of certain filtering actions on the listing of the options. For example, the results of a search for low-cost airfares may, in conventional systems, include line-by-line listings of flight options that may span over multiple internet web pages or be presented in a textual listing that is complex and not easily navigated. While some conventional systems may allow the user to filter the results of such a search, such systems do not provide the user with a graphical indication of what results may be eliminated by such a filtering operation. In addition, while some conventional search tools provide for the graphical display of price and/or departure options for products (such as low-fare airline tickets) in a more concise format (such as a multi-axis display), such tools do not provide the user with the ability to graphically filter the displayed options (by manipulating the range and/or axes of the graphical display) in order to tailor the output of the graphical display to their individual needs and/or search preferences. In addition, conventional search tools providing graphical displays of the options returned by a search also do not allow for the display to contain active embedded displays therein such that the user may select a particular point and/or section of the graphical display (corresponding to a low-cost option of interest, for example) and, in response, be presented with an embedded graphical display capable of displaying one or more additional option categories (aligned along one or more axes of the embedded display, for instance).

These limitations in the current system may create a burden on inventory systems. Specifically, as the user is not able to easily process results, the user is likely to run multiple searches in an attempt to find the needed information. Each time a new search is ran, it puts added burden on the inventory system to process the request. In some instances, added systems are required to meet the demand.

Therefore, there exists a need for an improved system to solve the technical problems outlined above that are associated with conventional search systems. More particularly, there exists a need for a system capable of providing different product options (in response to a search generated by, for example, a search algorithm) to a user in an interactive graphic format that allows the user to quickly review the multitude of options that may be returned by the search algorithm. In addition, there exists a need for a system that provides a user with a display of the product options in a concise graphical format. There also exists a need for such a system that interactively filters and/or adjusts the display of product options in a manner that allows a user to view the probable result of applying a filter to the display prior to the application of the filter such that the user may more effectively utilize the interactive graphic display to filter out unwanted product options.

### BRIEF SUMMARY OF THE INVENTION

The needs outlined above are met by the present invention which, in various embodiments, also provides a system that overcomes many of the technical problems discussed above, as well other technical problems, with regard to the display of product options by conventional low-cost product search systems. Specifically, in one embodiment, the system of the present invention is configured to be capable of generating an interactive graphical image of a plurality of product options selected from a database based on a search request.

According to some embodiments, the system comprises a user interface configured to be capable of receiving the search request as well as a user input selecting at least a portion of the product options and an interactive display in communication with the user interface and configured to be capable of displaying product options selected based on the search request. The interactive display is further configured to be capable of generating a graphical image including the product options displayed in relation to two axes corresponding to at least two corresponding criteria related to the product options. In addition, the interactive display is further configured to be capable of displaying the portion of the product options in a modified graphical image configured to be capable of depicting a result of the at least one user input on the graphical image so that the user may select an optimal product option from the product options.

In other embodiments, the system of the present invention may also be configured to be capable of receiving a second user input comprising at least one alternate criterion to replace at least one of the at least two corresponding criteria such that the interactive display is further configured to be capable of adjusting a format of the graphical image and the modified graphical image in response to the first and second user inputs. In addition, according to some embodiments of the present invention, the interactive display may be configured to to be capable of displaying both the graphical display and the modified graphical display simultaneously such that the user may select the portion of product options via the user interface via the graphical image and simultaneously view the resulting modified graphical image.

Further, the present invention also provides methods and/or computer program products for generating an interactive graphical image of a plurality of product options comprising providing a user interface configured to be capable of receiving at least a first user input and an interactive display configured to be capable of generating the graphical image depicting the product options, generating the graphical image of the product options via the interactive display (such as a monitor) in communication with the user interface wherein the graphical image comprises at least two axes corresponding to at least two criteria (such as price and/or departure date of an airline fare) related to the product options. In embodiments of the present invention wherein the product options comprise, for example, options for low cost airline fares, the criteria applied to the at least two axes of the interactive display may include, but are not limited to: a departure date; a return date; a fare cost; a departure time; a return time; a number of stops in a travel itenerary; and/or combinations thereof.

According to some embodiements, the methods of the present invention also comprise the steps of receiving a first user input from a user via the user interface (such as a selection of at least a portion of the plurality of product options); and generating a modified graphical image in response to the first user input, wherein the modified graphical image is configured to display the selected portion of the plurality of product options such that the user may view a result of the user input on the modified graphical image and thus be capable of selecting an optimal product option from the portion of the plurality of product options.

In some embodiments, the method and/or computer program product of the present invention may further comprise receiving a second user input from the user via the user interface, wherein the second user input includes at least one alternate criterion (such as, for example, a return date for an given airline fare) to replace at least one of the at least two corresponding criteria such that the user is further capable of controlling a format of the graphical image and the modified graphical image. In some embodiments, the graphical image comprises a graph, chart, a display embedded within another chart and/or graph, and/or another type of interactive graphical display suitable for depicting and efficiently sorting a plurality of product options selected from a database by a search algorithm.

In some additional embodiments, the receiving a user input step of the method of the present invention may further comprise receiving a selection of at least a portion of the plurality of product options wherein the selection comprises checking a box corresponding to the product options within the portion of the plurality of product options. In other alternative embodiments, the selection may comprise manipulating at least two slider bars in relation to the graphical image, wherein the at least two slider bars are configured to be substantially parallel to the at least two axes corresponding to the product options within the portion of the plurality of product options. Thus, in such emboidments, the user may select a maximum value for the at least one of the at least two criteria corresponding to the at least two axes by manipulating the slider bars in relation to the display.

Thus the systems, methods, and computer program products for generating an interactive display of a plurality of product options, as described in the embodiments of the present invention, provide many advantages that may include, but are not limited to: providing an interactive graphical representation of the of product options selected from a database by a search algorithm; providing the interactive graphical representation in a manner that allows a user to be aware of the distribution of the product options in relation to one or more criteria (such as cost, travel dates, or other criteria); allowing a user to view the potential results of a user input (such as the selection of a portion of the product options) and the effect of such a user input on the modified graphical image; allowing the user to select a product option directly from the modified graphical image; and allowing the user to “select” and/or “unselect” portions of the plurality of product options using “check boxes” and/or “filter bars” provided as part of the graphical image displayed via the interactive display.

These advantages and others that will be evident to those skilled in the art are provided in the system, method, and computer program product of the present invention. Importantly, all of these advantages allow the system to display results to a user in a more concise and organized manner. As the information is more readily digestible by the user, the user is less likely to run multiple queries that can overburden the inventory system.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a non-limiting example of the system for generating a graphical image of a plurality of product options selected from a database according to one embodiment of the present invention;

FIG. 2 shows a non-limiting example of the method for generating a graphical image of a plurality of product options selected from a database according to one embodiment of the present invention;

FIG. 3 shows a non-limiting example of a graphical image generated by the embodiments of the present invention including slider bars configured to be capable of selecting a value for the at least one of the at least two criteria corresponding to the at least two axes of the graphical image;

FIG. 4 shows a non-limiting example of a graphical image generated by the embodiments of the present invention including check boxes configured to be capable of selecting a value for the at least one of the at least two criteria corresponding to the at least two axes of the graphical image;

FIG. 5A shows a non-limiting example of a graphical image in the form of a chart depicting departure times versus cost for airline tickets generated by embodiments of the present invention;

FIG. 5B shows a non-limiting example of a graphical image in the form of a chart depicting departure dates versus return dates for airline tickets generated by embodiments of the present invention;

FIG. 6 shows a non-limiting example of a graphical image generated on an interactive display by the embodiments of the present invention wherein the interactive display is generating the graphical image and a modified graphical image simultaneously.

FIG. 7 shows a non-limiting example of a graphical image generated on an interactive display by the embodiments of the present invention wherein the interactive display may be manipulated using a variety of interactive user inputs;

FIG. 8 shows a resulting graphical image generated on an interactive display by the embodiments of the present invention wherein the resulting graphical image displays a selected portion of a plurality of product options so that a user of the present invention may select and confirm the purchase of a product option that most closely conforms to the user's product requirements; and

FIG. 9 shows an alternate non-limiting example of a graphical image generated on an interactive display by the embodiments of the present invention wherein the interactive display is generating the graphical image and a modified graphical image simultaneously.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. While the systems, methods, and computer program products of the present invention are described in an airline ticket reservation environment, it should be understood that this is only one non-limiting example of the possible use of the embodiments of the present invention. More specifically, the system, method, and computer program product embodiments of the present invention may be adapted to any number of products and services and are not limited to the display of low-cost product options provided in the airline industry (via a database such as a CRS). For example, the present invention may be used to select and interactively display product options related to various products that may include, but are not limited to, hotels, cruises, restaurants, car rentals, sports events, and/or leisure activities.

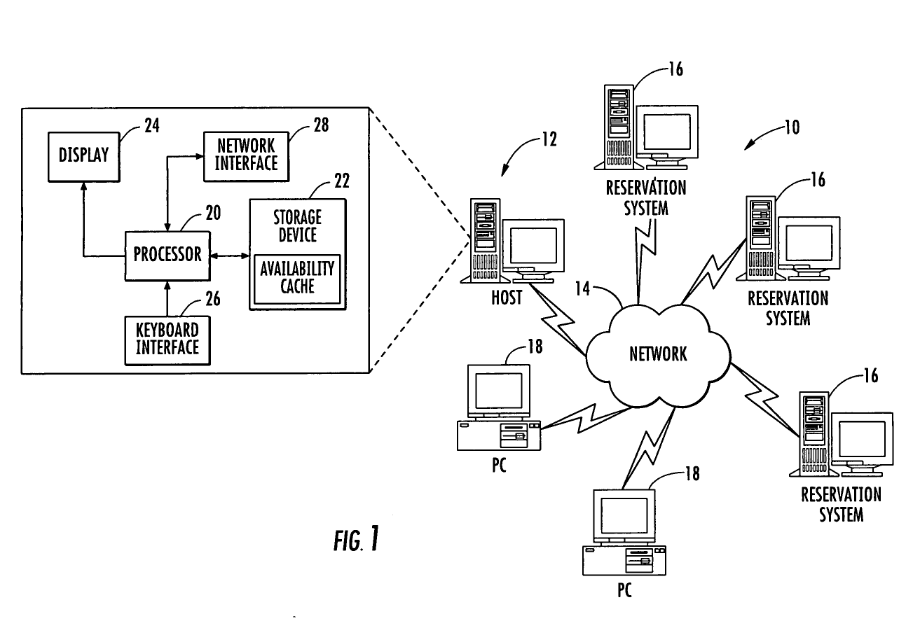

FIG. 1 illustrates an example of a typical conventional network environment 10 in which a travel reservation system is operated. The system typical includes a host computer 12 that operates a web site or other similar customer interface. The host computer is typically connected to a network 14, such as a LAN, WAN, Intranet, or Internet, for example. Also connected to the network are various inventory systems, such as computer reservation systems 16, for different products sources, such as hoteliers, airlines, car rental companies, etc. Further, customers are also connected to the network via interfaces, such as personal computers 18, or other types of computing systems. While not shown, the host computer may also be directly connected to either or both computing systems 16 and 18, in embodiments in which a network is not used to access the host computer.

As illustrated, the host computer system of the present invention is generally embodied as a typical computer, server or mainframe system depending on the embodiment. The system generally includes a processing element 20, such as a microprocessor, VLSI, ASIC, etc., a storage device 22, display 24, keyboard and mouse interface 26, and a network interface 28.

In operation, the travel reservation system, via the host computer 12, provides a web page or other similar electronic form to the customer. Using the web page, the customer inputs a travel related query. Based on this query, the host computer, in turn, polls the reservation systems 16 of the product providers for availability information. The host computer assimilates the results of these queries and provides them in a web page or other electronic form to the customer.

For example, a user may input a request for airline tickets for a given set of departure and destination locations and maybe a set of departure and return dates. Based on this query, the host computing element either uses stored cache or polls the inventory systems for airline flight information relating to the parameters of the query. The host computing element processes this data to determine available lowest fares and flight itineraries for which the fares are available. The host computing element creates a results listing in the form of a web page that is sent the user's computer. The user's computer then renders the web page using a browser to display the results to a user.

As discussed above, many airline customers are typically interested in finding the lowest ticket fare for their travel plans. Further, some customers may have flexible dates for departing and returning from travel that may allow the customer to adjust travel plans based on dates when the lowest fare is available. Other customers may be less concerned with getting the lowest fare and more concerned with the restrictions associated with the fare or the dates that a fare is available for departure and return. Further, some customers may prefer certain airlines and are willing to pay extra for the desired airline. It is very difficult in an inventory system to provide all of the different options to a user in a concise manner. One of the goals of the inventory system is to provide the information in such a way that the user does not feel the need to run excessive queries. The more queries that are ran, the more burden that is placed on the system.

In light of these concerns, the systems, methods, and computer program products provides of the present invention provide results, typically in the form of web pages, that provide information to the user in a more concise and informative manner. Specifically, the systems, methods, and computer program products of the present invention provide results in the forms of graphs. The graphs are manipulatible by the user so as to zoom in or out on data of interest. The graphs can take many forms. They typical include one travel option or product option along one axis graphed against another travel option or product option on the other axis. While typically two-dimensional graphs, (i.e., X,Y), the graphs can be displayed as three-dimensional, (i.e., X,Y,Z), representations of the three related travel or product options.

As a general matter, any option of a product can be graphed relative to another option. Price, availability, class, class of service, version, etc. of a product are typical parameters. For example, in the airline industry, the following options concerning airline tickets are typically considered important to a customer, and are thus subject to graphic representation: graphical image comprising the product options displayed with respect to at least two axes corresponding to at least two criteria selected from the group consisting of: departure date; return date; fare cost; departure time; return time; number of stops; cabin class; restrictions; refundability; etc.

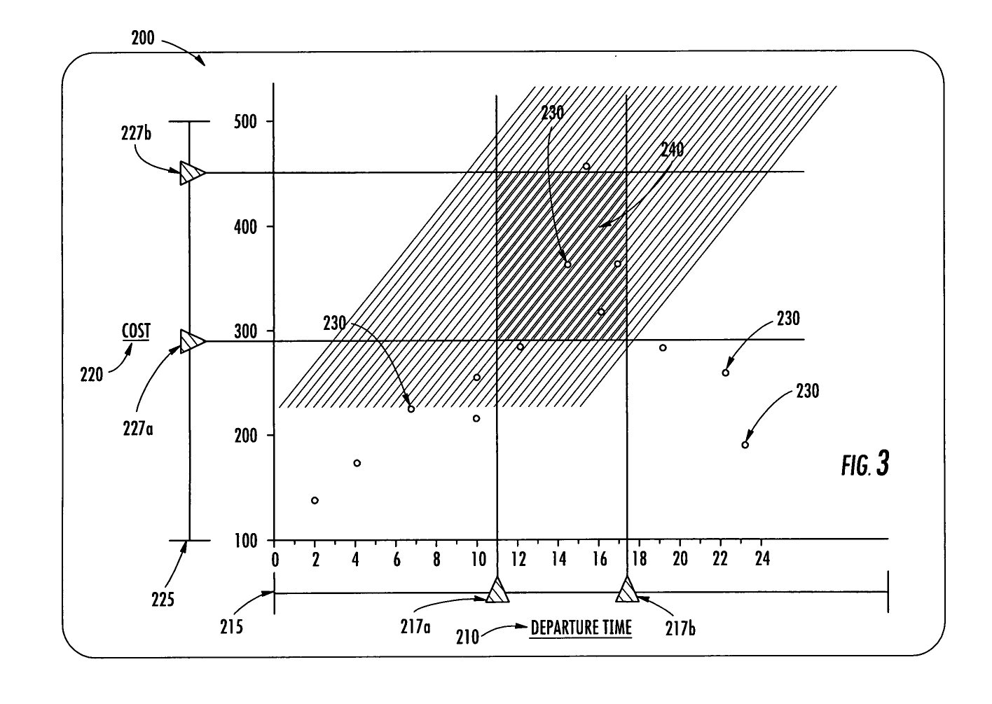

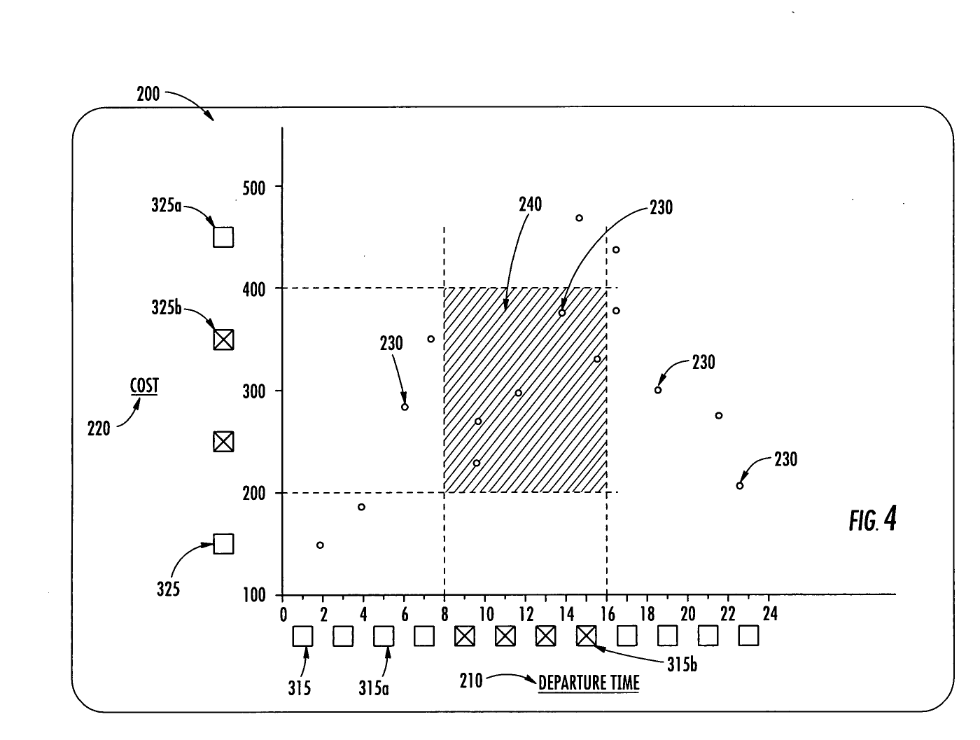

In general, the systems, methods, and computer program products of the present invention are configured to display product options in a graphical image 200 (such as shown generally in FIGS. 3-4) comprising at least two axes 210, 220 corresponding to at least two criteria related to the product options. Further, the present invention is configured to display a portion 240 of the plurality of product options 230 in a modified graphical image 200 such that the modified graphical image 200 depicts a result of the at least one user input on the modified graphical image such that the user may select an optimal product option from the portion 240 of the plurality of product options 230.

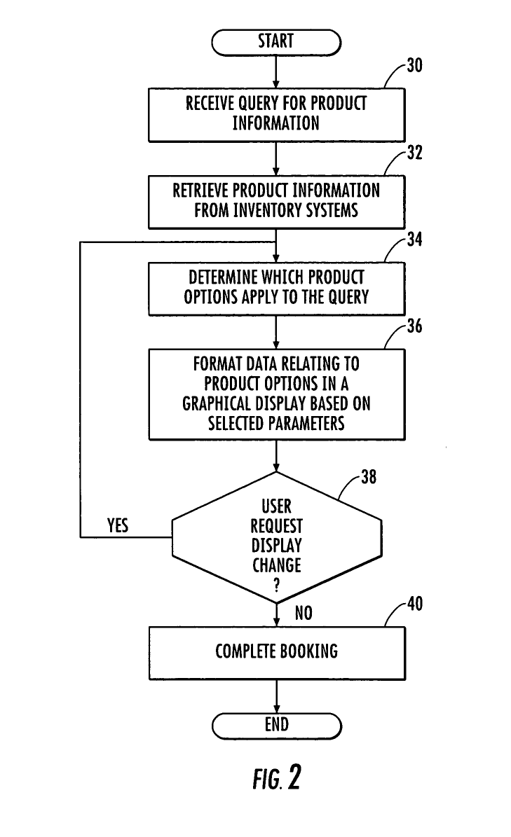

FIG. 2 illustrates an exemplary embodiment of the steps performed to generate the displays of FIGS. 3 and 4. Specifically, host computing element initially receives a query from a user via the user's computer. (See step 30). For example, if the query is for airline tickets, the query may include departure and arrival airport information. The host computing element either polls the inventory systems or accesses available cached data that includes a down load from the inventory systems. (See step 32). The host computing system next determines what product options will apply to the user's request. (See step 34). For example, if the request is for airline tickets, the host computing system will typically determine one or more lowest fares for the requested departure and arrival locations for different departure-return date combinations, such as is described in U.S. Provisional Patent Application Ser. No. 60/573,546 discussed above. Itineraries associated with the fares are then checked against various restrictions to determine which of the itineraries are available that meet the user's request. The host computing system then formats the data for the product options that meet the user's query based on a default set of parameters for each graphical axis. (See step 36). For example, if the product is airline tickets, the host computing element may take the data representing the cost of each fare and display it relative to the departure and return dates that the fare is available.

Following display of the initial graph, the system of the present invention further awaits input from the user. (See step 38). The user may either select a portion of the graph to review more closely, or the user may select to display alternative parameters of the product options. For example, instead of displaying fare cost versus departure and return dates, the user may wish to view fare costs versus one or more restrictions associated with the fare. If the user selects new criteria to display, the system receives the query, reformats the data, and generates a new results page that is sent to the user's computer for display. The system is further capable of receiving a request for booking information and booking a selected product as requested by the user. (See step 40).

FIG. 3 illustrates a graphical image 200 generated by the system, methods, and computer program products of the present invention wherein the product options 230 are displayed with respect to at least two axes 210, 220 corresponding to at least two criteria related to the product options. For example, as shown in FIG. 3, the product options 230 may include travel fare options returned from a database search. As described generally above, the system may receive at least one user input comprising a selection of at least a portion 240 of the plurality of product options 230 from a user.

Further the system is capable of displaying the portion 240 of the plurality of product options 230 in a modified graphical image 200 such that the modified graphical image 200 depicts a result of the at least one user input on the modified graphical image such that the user may select an optimal product option from the portion 240 of the plurality of product options 230. For example, as shown in FIG. 3, the system is capable of generating at least two slider bars 217a, 217b, 227a, 227b superimposed on the graphical image 200, such that the user may select a value for the at least one of the at least two criteria corresponding to the at least two axes 210, 220 by manipulating the at least two slider bars 217a, 217b, 227a, 227b. As shown in FIG. 3, the graphical image 200 may be generated with two slider bars 217a, 217b, 227a, 227b corresponding to each of the two axes 210, 220 such that the user may select the portion 240 of the plurality of product options 230 by manipulating a minimum value slider bar 217a, 227a and a maximum value slider bar 217b, 227b in order to select the portion 240 of the plurality of product options 230 from the graphical image.

In addition, as shown generally in FIG. 3, the system of the present invention is capable of generating a modified graphical image 200 by, for instance, highlighting the region of the graphical image 200 containing the selected portion 240 of the plurality of product options 230. Thus, the system of the present invention may solve the technical problems of conventional search and display systems by providing a concise graphical image 200 of the product options 230 returned by a search request relative to at least two criteria (such as departure time and fare cost, as shown in FIG. 3) and allowing a user to make a more informed selection from the plurality of product options 230. More specifically, as shown in FIG. 3, the modified graphical image 200 shows a selection 240 of product options 230 having a cost between about $300 and $450 and a departure time between 1100 hours and 1730 hours. The graphical image 200 generated by the system in FIG. 3, however, indicates to the user that lower-cost product options 230 are available for departure times just before (at 1000 hours, for example) and just after (1845 hours, for example) the range of departure times selected by manipulation of the slider bars 217a, 217b along the axis 210 corresponding to departure time. Thus, the system of the present invention, is capable of providing an interactive graphical image 200 of the product options returned by a search of product options 230 such that a user of the system may view all of the product options in a concise graphical format in relation to the selected portion 240 of the product options 230 presented via the modified graphical image 200.

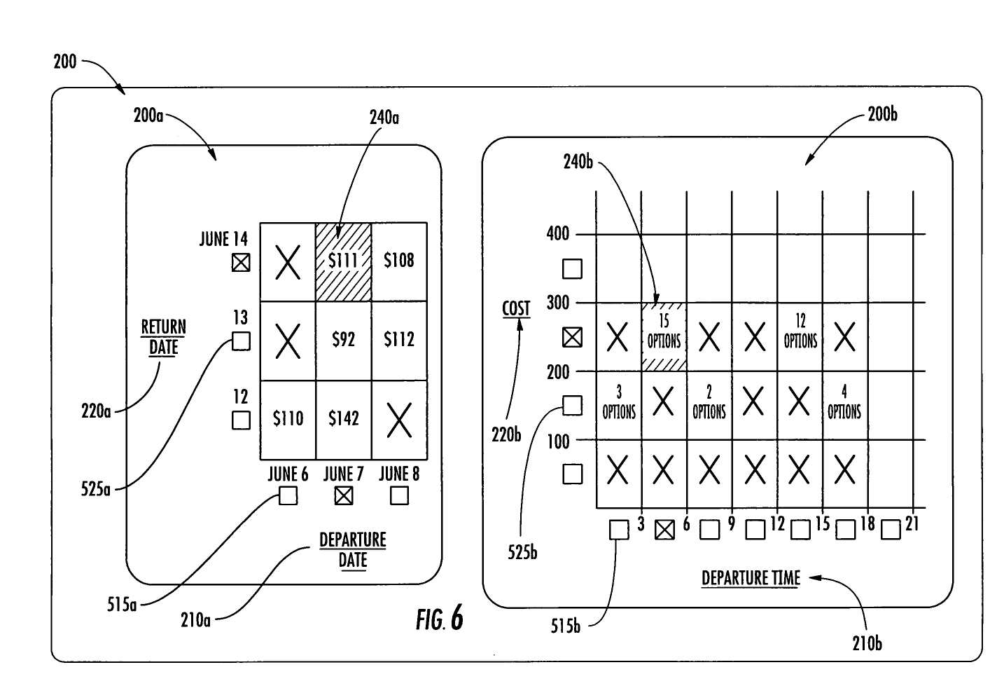

In other embodiments, as described more particularly below, the system of the present invention may be capable of providing the modified graphical image as an embedded graphical image in the original graphical image 100 and/or as a dependent chart (see generally, FIG. 6) that may be updated by the system in real time in response to the user inputs received by the user computer or interface.

FIG. 4 shows a graphical image 200 produced by the systems, methods, and computer program products according to another embodiment of the present invention wherein the system is capable of generating a plurality of check boxes 315, 325 corresponding to the product options 230 within the portion 240 of the plurality of product options 230. In the embodiment shown in FIG. 4, the system is further capable of receiving the user input comprising the selection of at least a portion 315b, 325b of the plurality of check boxes 315, 325 corresponding to at least a portion 240 of the plurality of product options 230. Thus, the system of this embodiment allows a user to select non-consecutive portions of the graphical image by selecting the checkboxes 315, 325 corresponding to selected ranges for the criteria corresponding to the axes 210, 220 of the graphical image 200. For instance, a user may select (along the X-axis 210, corresponding to a “departure time” criterion) product options 230 positioned on the graphical image 200 between the 0200 and 0400 time ranges as well as product options positioned between the 1000 and 1400 time ranges. In addition, the system generates the graphical image 200 of FIG. 2, further allowing the user to select two or more non-continuous ranges using check boxes 325 corresponding to ranges along the Y-axis 320 (corresponding, in FIG. 4, to a fare cost of a travel product option 230).

In addition, in some alternate embodiments, the system of the present invention is capable of receiving a second user input from the user, wherein the second user input comprises at least one alternate criterion to replace at least one of the at least two criteria corresponding to the axes 210, 220 of the graphical image 200 such that the system, typically via the host computing system, is capable of adjusting a format of the graphical image 200 and the modified graphical image in response to the first and second user inputs. For example, the second user input may comprise the click of a computer mouse, the scrolling of a thumbwheel, manipulation of a trackball, or typing of characters on a computer keyboard in order to replace one or more of the criteria corresponding to the axes 210, 220 of the graphical image 200 such that the system may more effectively generate a graphical image 100 showing the product options 230 relative to the criteria that are most relevant to the needs of a particular user. For example, in some embodiments, the system may enable the X-axis 210 shown in FIG. 3 to be selected (via the click of a mouse or another second user input) in order to inititate a pull-down menu, blank text entry point, or other menu such that a user may choose and/or enter one or more alternate criteria to replace the “departure time” criteria shown on the X-axis 210 of the graphical image 200 of FIG. 3. Similarly, the systems, methods, and computer program products of the present invention may also be configured such that a user may also select alternate criteria for the Y-axis 220. Thus, the system may be capable of interactively altering the criteria (and the resulting format) of the graphical image 200 in response to the second user input described above such that the user may tailor the graphical display to display the product options 230 relative to selected criteria that are most relevant to the user's needs.

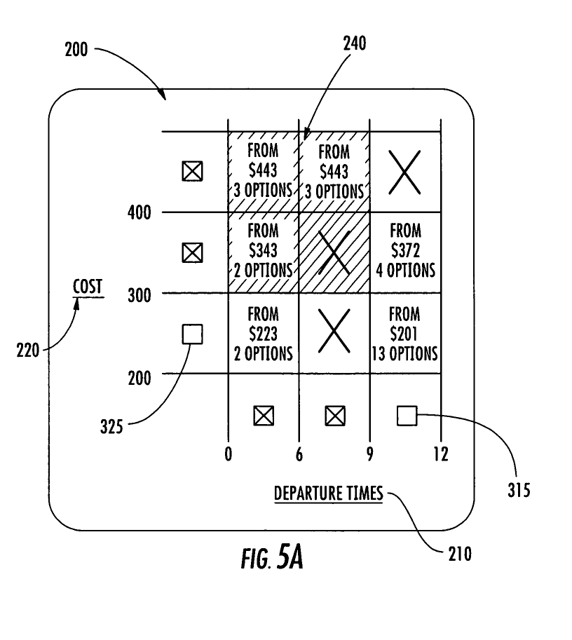

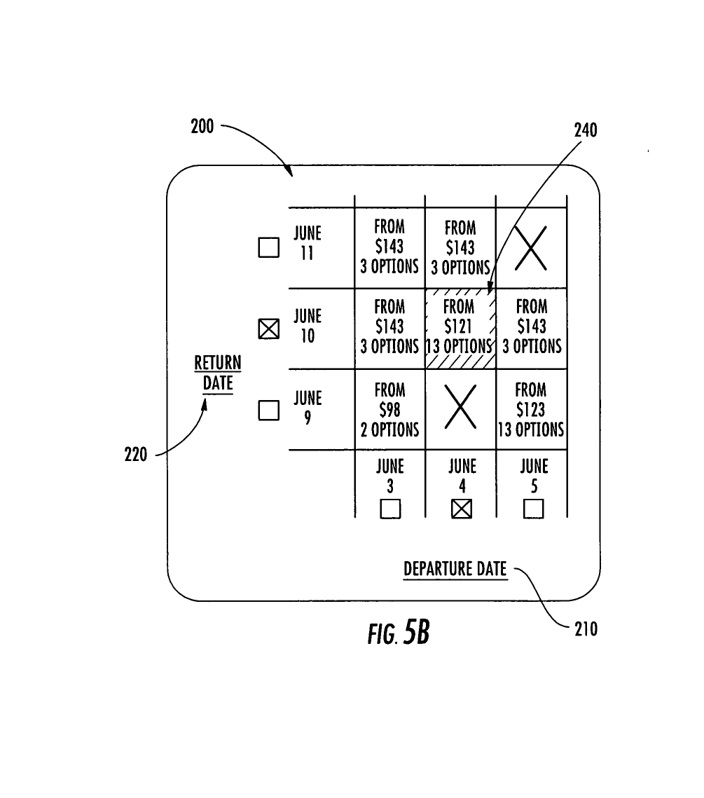

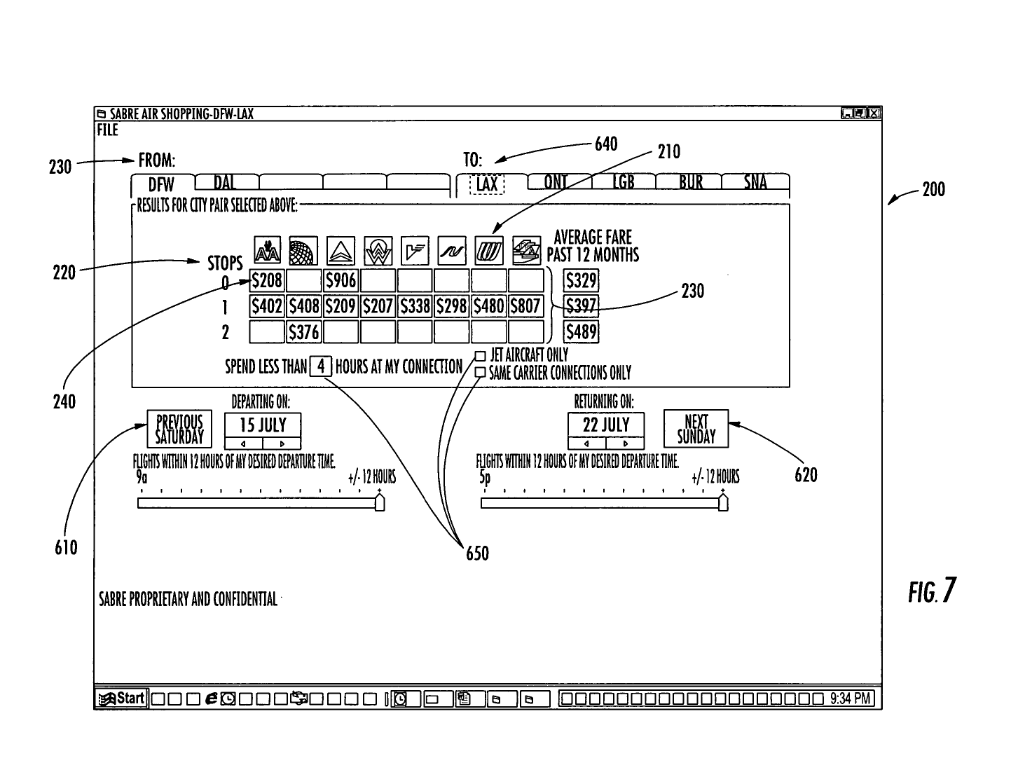

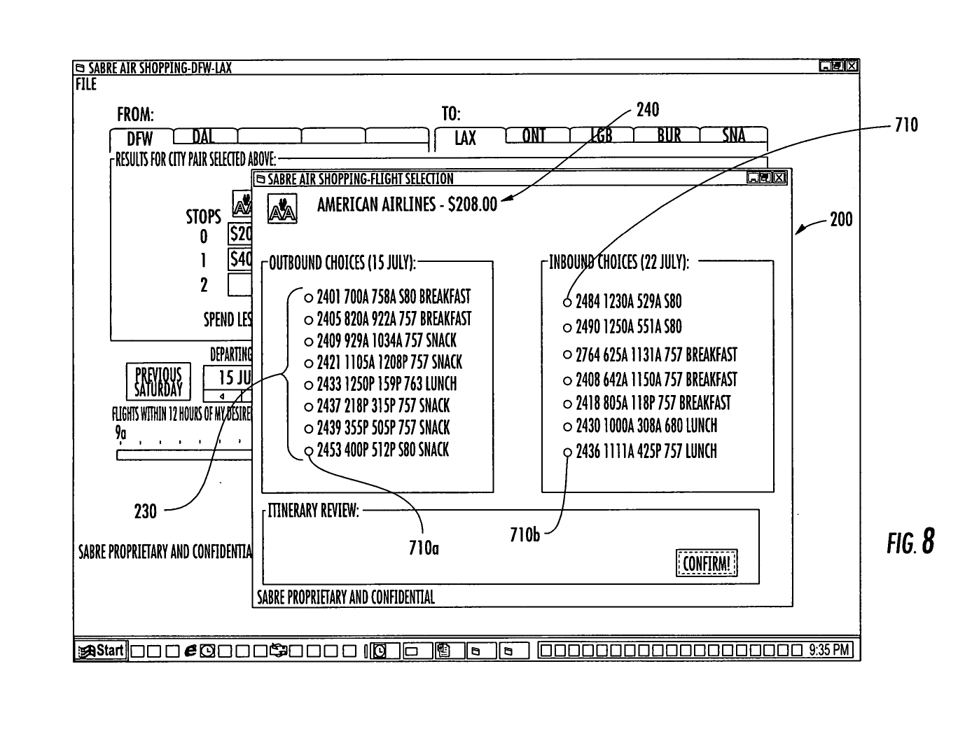

According to various embodiments of the present invention, the systems, methods, and computer program products may be further configured to be capable of generating a graphical image such as: a graph (as shown generally in FIGS. 3-4), a chart (as shown generally in FIGS. 5A-5B) and/or an embedded or dependent display (as shown generally in FIG. 6, wherein the graphical image 200 generated includes an interactive graphical image 200 as well as a modified resulting image presented in real time via the user's interface or computer in response to the user inputs selecting a portion 240 of the product options 230). In addition, FIGS. 7-8 show an example of an interactive graphical image 200 that may be generated by some embodiments of the present invention such that a user of the present invention may choose a portion 240 of the product options 230 to generate a modified resulting image such as that shown generally in FIG. 8 that displays, for example, a detailed listing of product options within the chosed portion 240 of product options 230. For instance, as shown in FIGS. 5A and 5B the system of the present invention may be capable of generating the graphical image 200 of the product options 230 in relation to the axes 210, 220 corresponding to criteria (such as cost, departure times/dates, and/or return times/dates) in a chart format such that the product options 230 are summarized in a short text message or other visual cue displayed to the user. More particularly, as shown in FIG. 5A, the graphical image 200 generated by the system of the present invention may include criteria related to travel product options 230 (such as airline fares) present in a chart having an X-axis 210 corresponding to departure times and a Y-axis 220 corresponding to fare costs. According to the embodiment shown in FIG. 5A, a user may, via the user interface, select one or more checkboxes 315, 325 in order to select a portion 240 of the product options shown in the chart. In response to the selection of a portion 240 of the product options, the system may then generate a modified graphical image 200 that may present, in greater detail, criteria related to individual product options 230 within the portion 240 of product options selected in the initial graphical image 200 (shown, for example, in FIG. 5A.) In addition, as described above with respect to the system embodiments capable of generating the graphical display 200 of product options 230 as a graph (see, for example, FIGS. 3-4), some embodiments of the system of the present invention may be further configured to be capable of receiving a second user input comprising the selection of one or more alternate criteria corresponding to the axes 210, 220 of the graphical image 200. Thus, as shown generally in FIG. 5B, some system embodiments are capable of allowing a user to select the criteria corresponding to the chart axes 210, 220 such that criteria such as cost and departure times (as shown in FIG. 5A, may be replaced with alternate criteria such as, for example, return and departure dates (as shown in FIG. 5B).

The systems, methods, and computer program products of the present invention that are capable of generating graphical images of the plurality of product options 230 in a chart format (as shown, for example, in FIGS. 5A-5B) may further be configured to be capable of depicting a subset of product options in a summary format within a given cell or segment of the chart. For example, as shown in FIG. 5A, the chart cell corresponding to the X-axis (departure time) 210 range between 0000 and 0600 hours and the Y-axis (cost) 220 range between $200 and $300 may be generated with summary text generally describing the distinct, individual product options 230 (see FIG. 3) by, for example, the number of options (2) within the selected portion and the minimum fare cost ($223) within the selected portion of the plurality of product options 230. In addition, as described above, upon receiving the user input corresponding to the selection of the portion 240 of the graphical image 200 such as that shown in FIG. 5A, the system may be configured to be capable of generating a dependent modified graphical image 200 comprising a more detailed view of the product options 230 available within the selected portion 240 of the plurality of product options 230 in a format, for example, similar to that shown in FIG. 3. In addition, in alternate embodiments, the dependent modified graphical image may comprise an embedded graphical image in a chart format (such as that shown generally in FIGS. 5A and 5B) that includes detailed textual descriptions of particular product options 230. Such detailed textual descriptions may include, for instance, airline information, number of stops in a travel itenerary, aircraft type, meal service provided on the flight, and/or other details specific to the product option displayed in the modified graphical image 200.

As shown in FIG. 6, and according to an alternate embodiment, the system of the present invention may be capable of generating a comprehensive graphical display 200 that includes a base graphical display 200a and a modified graphical display 200b that shows a plurality of product options (such as airline tickets) in relation to a modified graphical display having axes 210b, 220b that provide additional information related to the portion 240a of product options selected in the base graphical display having axes 210a, 220b. In addition, the system of such embodiments may be further capable of generating the base graphical image 200a and the modified graphical image 200b simultaneously as part of the comprehensive graphical display 200 such that a user of the system may view, in real time and/or near-real time, the results of the selection of the portion 240a of product options in the base graphical image 200a in the modified graphical image 200b.

Thus, in the embodiments shown in FIG. 6, the system may solve the technical problems inherent in the static graphical displays of conventional search systems by allowing a user to view (in an interactive format) more than 2 criteria related to the product options returned by a product search. For example, as shown in FIG. 6, the user may select (via the the check boxes 515a, 525a) a portion 240a of the product options 230 corresponding to a departure date (June 7) on the X-axis 210a and a return date (June 14) on the Y-axis (220a). The system then simultaneously displays (via the modified graphical image 200b) the portion 240a of the product options selected from the base graphical display 200a relative to an additional, alternate set of criteria (departure time, and cost) corresponding to the axes 210b, 220b of the modified graphical image 200b. The system may also provide check boxes 515b, 525b in the modified graphical display 200b such that the user may select a second, more refined, subset 240b of the portion 240a of product options originally selected in the base graphical image 200a. Thus, the system may provide the user with product options using a stepwise approach wherein the user may narrow the portions 240a, 240b selected from the product options using a series of two or more graphical displays 200a, 200b depicting product options relative to criteria (arranged along the axes 210a, 210b, 220a, 220b of the respective graphical images) that are most important to the user of the system. In addition, the system embodiments shown generally in FIG. 6 may further be configured to be capable of allowing a user to choose the particular criteria used to label the axes 210a, 210b, 220a, 220b of the respective graphical images 200a, 200b using, for instance, the system may be be capable of actuating a pull-down menu, text box, check boxes, and/or other graphical tools that may be embedded in the graphical images 200a, 200b in order to allow the user to modify the overall format and content of the display to better serve the individual searching needs of a particular user.

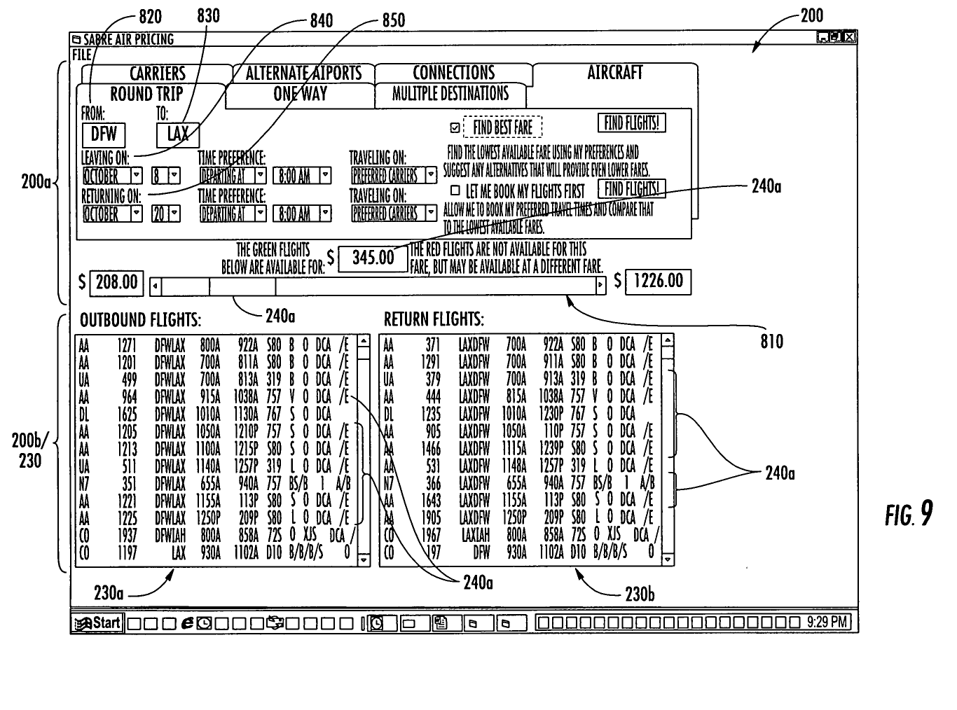

FIG. 9 shows an alternate embodiment of the system of the present invention wherein the system may be capable of generating a comprehensive graphical display 200 that includes a base graphical display 200a and a modified graphical display 200b that shows a plurality of product options 230 (such as airline ticket itnenaries for outbound flights 230a and return flights 230b) in a modified graphical display 200b that may be color coded to highlight the selected portion 240a of the product options 230a/230b. In addition, the system of such embodiments may be further capable of generating the base graphical image 200a and the modified graphical image 200b simultaneously (as also described above with respect to FIG. 6) as part of the comprehensive graphical display 200 such that a user of the system may view, in real time and/or near-real time, the results of the selection of the portion 240a of product options 230 in the base graphical image 200a in the modified graphical image 200b.

More particularly, the system embodiment of FIG. 9 may generate a comprehensive graphical display 200 comprising a base graphical image 200a wherein the user may provide inputs such as selected departure and return travel dates 840, 850 selected departure and destination airports 820, 830. Such inputs 820, 830, 840, 850 may be received by the system via pull-down menus, text boxes, check boxes, and/or other graphical tools that may be embedded in the graphical images 200a, 200b in order to allow the user to modify the format of the comprehensive graphical display 200. In addition, the system embodiment capable of generating the comprehensive graphical display 200 shown in FIG. 9 may further be capable of displaying a range of prices corresponding to the selected user inputs 820, 830, 840, 850 wherein the price range is displayed on an X-axis 810 (represented by a slider bar graphical tool 810) such that a user may manipulate the slider bar 810 to highlight a selected portion 240a of product options 230. Further, the system of this embodiment may display (via the simulataneous modified graphical image 200b) the selected portion 240a of product options (such as a flight iteneraries) in color codes (such as, for example, green for the selected portion of product options 240a corresponding to the price selected via the slider bar 810). In addition, as shown in FIG. 9, the outbound 230a and return 230b product options displayed in the modified graphical display 200b may include specific information related to the product options 230a/230b including, but not limited to, flight numbers, aircraft type, departure airport, destination airport, fare codes, connection airport, departure and arrival times, boarding times, and gate information. Thus, the user may utilize this system embodiment to view detailed information related to a selected portion 240a of product options 230 available for both outbound flights 230a and return flights 230a that correspond to a selected price point that may be selected via the slider bar 810 serving as the X-axis in the base graphical image 200a. In response to manipulation of the slider bar 810 (and various other user inputs 820, 830, 840, 850), the system shown in FIG. 9 may, in real-time or near real-time, update the color codes or other graphical details of the modified graphical display 200b such that the user may view the selected product options 240a relative to all available product options 230a, 230b for both outbound 230a and return 230b flights. Thus, using the embodiments of the system of the present invention, the user may be made quickly aware of more convenient travel iteneraries (that may be viewed in real-time or near real-time relative to other itenerary options in the modified graphical display 200b) that may be made available for only small changes in fare price as selected in the base graphical display 200a.

According to another embodiment of the system of the present invention, as shown generally in FIG. 7, the system may be capable of generating a graphical image 200 of the plurality of product options 230 (such as airline travel iteneraries) in a chart format having axis labels 210, 220 corresponding to one or more attributes (such as airline and number of stops) of the itenerary options 230. For example, as shown in FIG. 7, the X-axis 210 depicts a listing of airlines (by logo or trademark, for example) and the Y-axis 220 lists a possible number of stops in a travel itenerary offered by one of the airlines shown in the graphical image 200. In addition, according to the system embodiment shown in FIG. 7, a user of the system may input various intenary selections in order to generate the initial graphical image. For instance, the graphical image 200 generated by the system may include a departure date input area 610 and a return date input area wherein a user may enter selected departure and return dates in order to generate the results shown in the graphical image 200. In addition, as shown in FIG. 7 the system may generate a graphical image 200 that also allows the user to enter selected departure and destination location inputs using a departure location tab 630 and destination location tab 640 that may further affect the listed product options 230 displayed by the system in the graphical image 200. Also, as shown in FIG. 7 the graphical image 200 generated by the system may further include additional travel itenerary inputs 650 that may include, for example, a maximum time spent at a connecting airport, a restriction to same-carrier connections only, and/or a restriction that the legs of a travel itenerary be limited to jet aircraft service only. According to alternate embodiments, the system may further generate a graphical image 200 having axes 210, 220 that may include departure date and return date 210a, 220a as shown generally in FIG. 6A. In such alternate embodiments, the graphical image 200 generated by the system may include alternate user input areas that may allow the user to input alternative inputs that are not shown on the axes 210, 220 of the graphical image 200, including, for example, restrictions to a particular airline or number of stops in an itenerary. In addition, as described above, upon receiving a user input (such as a click of a computer mouse, check-box, or other input method) corresponding to the selection of the portion 240 of the graphical image 200 (such as the $208 dollar fare corresponding to the selected airline 240 shown in FIG. 7), the system may be configured to be capable of generating a modified graphical image 200 shown generally in FIG. 8, comprising a more detailed view of the product options 230 available within the selected portion 240 of the plurality of product options 230. The modified graphical image 200 generated by the system as shown in FIG. 8 may thus allow a user to input a precise input selection (via the selection of a check-box 710a corresponding to a particular flight, time of departure, and aircraft type. In addition, the user may also select a check box 710b corresponding to a particular flight, time of departure, and aircraft type for the return journey in order to select and confirm a specific travel itenerary (or other product option) that most closely meets the requirements of the user.

According to another embodiment of the present invention, a method for generating a graphical image 200 of a plurality of product options 230 selected from a database based on a search request is provided and shown generally in FIGS. 1-3. The method comprises receiving at least a first user input and generating the graphical image 200 depicting the product options 230 and generating the graphical image 200 of the product options 230 comprising at least two axes 210, 220 corresponding to at least two criteria related to the product options 230. In addition, the method also comprises receiving a first user input from a user, wherein the first user input includes a selection of at least a portion 240 of the product options 230, and generating a modified graphical image 200b (see FIG. 6, for instance) in response to the first user input. According to various method embodiments of the present invention, the modified graphical image 200 is configured to be capable of displaying the portion 240 of the plurality of product options 230 such that the user is capable of viewing a result of the user input on the modified graphical image 200b and is thus receives more complete information regarding the entire set of product options 230 when selecting an optimal product option from the plurality of product options 230.

For example, as described above with respect to the system embodiments of the present invention, the modified graphical image 200 generated according to the method embodiments of the present invention may comrpise an embedded display and/or a dependent graphical display 200b (in some cases generated simultaneously with the base graphical display 200a as shown in FIG. 6). According to various method embodiments the graphical image 200 generated may comprise images including, but not limited to: graphs, charts, embedded charts, hyperlinked displays, text annotations, digital images, and other images suitable for displaying the plurality of product options 230. In addition, as shown generally in FIG. 3, the modified graphical display 200 may comprise a shaded, highlighted, and/or otherwise marked portion 240 of the graphical display 200 corresponding to the portion 240 of the plurality of product options 230 selected by a user. Thus, the method of the present invention provides distinct advantages over the displays provided by conventional search systems which do not provide a graphical indication of the location, orientation, and relative size of the selected subset with respect to the overal plurality of product options. In addition, the modified graphical image 200 generated according to the method embodiments of the present invention present a user with a concise indication of the entire range of product options relative to a selected portion 240 of the product options 230 so that the user may, in turn, make a fully-informed decision as to the selection of the portion 240 of product options 230 as well as the selection of a particular optimal product option 230 that best serves the user's needs relative to a variety of different criteria corresponding to the axes 210, 220 of a concise graphical image 200.

In addition, the method embodiments of the present invention may also comprise the additional step of receiving a second user input from the user wherein the second user input comprises at least one alternate criterion to replace at least one of the at least two criteria corresponding to the axes 210, 220 of the graphical image 200 such that the user is further capable of controlling a format of the graphical image 200 and the modified graphical image. Thus, as described above with respect to the system embodiments of the present invention, the method of the present invention allows a user to replace one or more of the criteria corresponding to the axes 210, 220 of the graphical image 200 with one or more alternate criteria related to the product options 230 (see, for example, FIGS. 5A and 5B). For example, according to various method embodiments of the present invention wherein the product options 230 comprise travel fare options, the generating the graphical image step further comprises generating an image comprising at least two axes corresponding to at least two criteria including, but not limited to: a departure date, a return date, a fare cost, a departure time, a return time, a number of stops, and combinations thereof.

In some alternate method embodiments of the present invention, the receiving step further comprises receiving a selection of at least a portion 240 of the plurality of product options 230 via the selection of a check box 315, 325 (see FIG. 4) corresponding to the product options 230 within the portion 240 of the plurality of product options. In addition, as shown generally in FIG. 3, the receiving step, in some embodiments, further comprises receiving the selection of at least a portion 240 of the plurality of product options 230 via the manipulation of at least two slider bars 217a, 217b, 227a, 227b, configured to be substantially parallel to the at least two axes 210, 220 such that the user is capable of selecting a maximum value for the at least one of the at least two criteria corresponding to the at least two axes 210, 220 by manipulating the at least two slider bars 217a, 217b, 227a, 227b.

In addition, it should be understood that the various method embodiments of the present invention described above may also be embodied in a computer program product capable of controlling the system to generate a graphical image 200, via the interactive display 200, of the product options 230 selected from a database or inventory system by a search algorithm. The computer program product comprises a computer-readable storage medium having computer-readable program code portions stored therein, the computer-readable program code portions comprising executable portions for performing the various steps of the method embodiments of the present invention. For example, the computer program product embodiments of the present invention may include an executable portion for controlling the system of the present invention such that the interactive display is configured to be capable of generating the graphical image 200 of the product options 230 selected by the search algorithm wherein the graphical image comprises at least two axes 210, 220 corresponding to at least two criteria related to the product options 230. In addition, the computer program product embodiments of the present invention may also include executable portions for: (1) receiving a first user input from a user comprising a selection of at least a portion 240 of the plurality of product options 240; (2) generating a modified graphical image in response to the first user input so as to display the portion 240 of the plurality of product options 240. Thus, as described above with respect the system and method embodiments of the present invention, the computer program embodiments better enable a user to view a result of the user input on the modified graphical image such that the user may select an optimal product option 230 from the plurality of product options.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for generating a graphical image of a plurality of product options selected from a database based on a search request in a manner that reduces the burden on inventory systems, the system comprising:
an inventory system comprising a database comprising product options for at least one product;
a host computing element in communication with said inventory system for running queries on said inventory system for availability information related to product options stored in said inventory system;
an interface in communication with said host computing system, said interface capable providing queries from a user to said host computing system and displaying results from the query to the user,
wherein said host computing element provides results to said interface, wherein the results comprise product options illustrated in a graphical image with respect to at least two axes corresponding to at least two criteria related to the product options, and
whereing said host computing system, in response to user input from said interface, creates a modified results in the form of a modified display so that the user may select an optimal product option from the portion of the plurality of product options from the modified display.

2. A system according to claim 1, wherein said host computing element receives a second input from a user, the second user input comprising at least one alternate criterion to replace at least one of the at least two criteria, wherein said host computing element reformats the results for display based on the first and second user inputs.

3. A system according to claim 1, wherein said host computing element configures the results so that both the graphical image and the modified graphical image can be simultaneously displayed by said interface.

4. A system according to claim 1, wherein said host computing system configures the results so that it is displayable as a graphical image selected from the group consisting of:
a graph;
a chart;
an embedded display; and
combinations thereof.

5. A system according to claim 1, wherein said host computer element includes a plurality of check boxes displayable with the results, wherein the check boxes corresponding to different product options within the portion of the plurality of product options and wherein said user interface is capable of receiving the user input comprising the selection of at least a portion of the plurality of check boxes corresponding to at least a portion of the plurality of product options.

6. A system according to claim 1, wherein said host computing element includes with said results at least two slider bars superimposed on the graphical image, the at least two slider bars configured to be substantially parallel to the at least two axes corresponding to the product options within the portion of the plurality of product options, and wherein the user interface is capable of receiving the user input comprising selecting a value for the at least one of the at least two criteria corresponding to the at least two axes by manipulating the at least two slider bars.

7. A system according to claim 1, wherein said host computing element generates results that include a graphical image comprising the product options displayed with respect to at least two axes corresponding to at least two criteria selected from the group consisting of:
a departure date;
a return date;
a fare cost;
a departure time;
a return time;
a number of stops; and
combinations thereof.

8. A system according to claim 1, wherein said host computing element generates results that include a graphical logo associated with the product illustrating the source of the product.

9. A system according to claim 1, wherein said host computing element generates results that include a graphical icon indicating the type of product option.

10. A system according to claim 1, wherein said host computing element generates the results as a graphical display that discloses the price of a product option for different time frames that the price is available.

11. A system according to claim 1, wherein the product option is an airline ticket, wherein said host computing element for different dates displays the price of the airline ticket.

12. A system according to claim 1, wherein the product options are travel products, and wherein said host computing element generates results that are displayable by said interface that display the travel options.

13. A method for generating a graphical image of a plurality of product options selected from a database based on a search request in a manner that reduces the burden on inventory systems, the method comprising:
receiving a request for availability of at least one product option;
querying at least one inventory system for availability information related to requested product option; and
generating results that are displayable by an interface, wherein said generating step generates a first result comprising product options illustrated in a graphical image with respect to at least two axes corresponding to at least two criteria related to the product options, and, in response to user input, generating a modified results in the form of a modified display so that the user may select an optimal product option from the portion of the plurality of product options from the modified display.

14. A method according to claim 13 further comprising receiving a second input from a user, the second user input comprising at least one alternate criterion to replace at least one of the at least two criteria, wherein said generating step generates a results representing a reformatted display based on the first and second user inputs.

15. A method according to claim 13, wherein said generating step generates the results so that both the graphical image and the modified graphical image can be simultaneously displayed.

16. A method according to claim 13, wherein said generating step configures the results so that it is displayable as a graphical image selected from the group consisting of:
a graph;
a chart;
an embedded display; and
combinations thereof.

17. A method according to claim 13, wherein said generating step generates a plurality of check boxes displayable with the results, wherein the check boxes corresponding to different product options within the portion of the plurality of product options and wherein said receiving step further comprises receiving user input comprising the selection of at least a portion of the plurality of check boxes corresponding to at least a portion of the plurality of product options.

18. A method according to claim 13, wherein said generatng step generates results that include at least two slider bars superimposed on the graphical image, the at least two slider bars configured to be substantially parallel to the at least two axes corresponding to the product options within the portion of the plurality of product options, and said receiving step receives user input comprising selecting a value for the at least one of the at least two criteria corresponding to the at least two axes by manipulating the at least two slider bars.

19. A method according to claim 13, wherein said generating step generates results that include a graphical image comprising the product options displayed with respect to at least two axes corresponding to at least two criteria selected from the group consisting of:
a departure date;
a return date;
a fare cost;
a departure time;
a return time;
a number of stops; and
combinations thereof.

20. A method according to claim 13, wherein said generating step generates results that include a graphical logo associated with the product illustrating the source of the product.

21. A method according to claim 13, wherein said generating step generates results that include a graphical icon indicating the type of product option.

22. A method according to claim 13, wherein said generating step generates the results as a graphical display that discloses the price of a product option for different time frames that the price is available.

23. A method according to claim 13, wherein the product option is an airline ticket, wherein said generating step for different dates generates results that display the price of the airline ticket.

24. A method according to claim 13, wherein the product options are travel products, and wherein said generating step generates results that display the travel options.

25. A computer program product for generating a graphical image of a plurality of product options selected from a database based on a search request in a manner that reduces the burden on inventory systems, the computer program product comprising a computer-readable storage medium having computer-readable program code instructions stored therein comprising:
first instruction means for receiving a request for availability of at least one product option;
second instruction means for querying at least one inventory system for availability information related to requested product option; and
third instruction means for generating results that are displayable by an interface, wherein said third instruction means generates a first result comprising product options illustrated in a graphical image with respect to at least two axes corresponding to at least two criteria related to the product options, and, in response to user input, generates a modified results in the form of a modified display so that the user may select an optimal product option from the portion of the plurality of product options from the modified display.

26. A computer program product according to claim 25 further comprising fourth instruction means for receiving a second input from a user, the second user input comprising at least one alternate criterion to replace at least one of the at least two criteria, wherein said third instruction means generates a results representing a reformatted display based on the first and second user inputs.

27. A computer program product according to claim 25, wherein said third instruction means genertes the results so that both the graphical image and the modified graphical image can be simultaneously displayed.

28. A computer program product according to claim 25, wherein said third instruction means configures the results so that it is displayable as a graphical image selected from the group consisting of:
a graph;
a chart;
an embedded display; and
combinations thereof.

29. A computer program product according to claim 25, wherein said third instruction means generates a plurality of check boxes displayable with the results, wherein the check boxes corresponding to different product options within the portion of the plurality of product options and wherein said first computer instruction means further comprises receiving user input comprising the selection of at least a portion of the plurality of check boxes corresponding to at least a portion of the plurality of product options.

30. A computer program product according to claim 25, wherein said third instruction means generates results that include at least two slider bars superimposed on the graphical image, the at least two slider bars configured to be substantially parallel to the at least two axes corresponding to the product options within the portion of the plurality of product options, and said first instruction means receives user input comprising selecting a value for the at least one of the at least two criteria corresponding to the at least two axes by manipulating the at least two slider bars.

31. A computer program product according to claim 25, wherein said third instruction means generates results that include a graphical image comprising the product options displayed with respect to at least two axes corresponding to at least two criteria selected from the group consisting of:
a departure date;
a return date;
a fare cost;
a departure time;
a return time;
a number of stops; and
combinations thereof.

32. A computer program product according to claim 25, wherein said third instruction means generates results that include a graphical logo associated with the product illustrating the source of the product.

33. A computer program product according to claim 25, wherein said third instruction means generates results that include a graphical icon indicating the type of product option.

34. A computer program product according to claim 25, wherein said third instruction means generates the results as a graphical display that discloses the price of a product option for different time frames that the price is available.

35. A computer program product according to claim 25, wherein the product option is an airline ticket, wherein said third instruction means for different dates generates results that display the price of the airline ticket.

36. A computer program product according to claim 25, wherein the product options are travel products, and wherein said third instruction means generates results that display the travel options.
